(19) United States
(12) Patent Application Publication
(10) Pub. No.: US 2026/0223863 A1
(43) Pub. Date: Aug. 6, 2026

(54) AGROCHEMICAL COMPOSITION

(71) Applicants: UPL MAURITIUS LIMITED, Port Louis (MU); UPL EUROPE SUPPLY CHAIN GMBH, Rotkreuz/Risch (CH)

(72) Inventor: Robert Burton, Evesham Worcestershire (GB)

(73) Assignees: UPL MAURITIUS LIMITED, Port Louis (MU); UPL EUROPE SUPPLY CHAIN GMBH, Rotkreuz/Risch (CH)

(21) Appl. No.: 19/157,923

(22) PCT Filed: Feb. 20, 2024
(86) PCT No.: PCT/EP2024/054267

§ 371 Date: Aug. 19, 2025

(30) Foreign Application Priority Data
Feb. 20, 2023 (GB) 2302379.9

(51) Int. Cl. A01N 65/36; A01N 25/04; A01N 25/12; A01N 27/00; A01N 59/02; A01N 59/20; A01P 3/00; A01P 7/04; A01P 21/00

(52) U.S. Cl. CPC A01N 65/36; A01N 25/04; A01N 25/12; A01N 27/00; A01N 59/02; A01N 59/20; A01P 3/00; A01P 7/04; A01P 21/00

(57) ABSTRACT

The present disclosure relates to agrochemical combinations, compositions, and methods for controlling pest infestation in crops. The present disclosure more particularly relates to a suspoemulsion formulation comprising sulphur and orange oil, wherein orange oil is adsorbed onto precipitated silica.

### TECHNICAL FIELD

The present disclosure relates to agrochemical combinations, compositions, and methods for controlling pest infestation in crops. The present disclosure more particularly relates to a suspoemulsion formulation.

### BACKGROUND

Sulphur is generally applied to crops to combat fungal diseases, as well as for postharvest disease control. The range of fungal diseases controlled by sulphur includes brown rot, scab, mildew, powdery mildew, leafspot, leaf blights and rusts. It is also used, to a lesser extent, for the control of mites and insects, which may be secondary to fungal damage of the plant. Sulphur is generally used as dust, paste, wettable powder and in the liquid form. It may be persistent in soil but as a naturally occurring substance it is unlikely to cause significant environmental problems. Sulphur tends to have low toxicity to most species. It has low mammalian toxicity if ingested and, may be a respiratory and skin irritant.

Essential oils are known for their pesticidal properties including fungicidal, herbicidal, and insecticidal as well as for repellent and antioxidant activities. Essential oils are natural plant products having multi-component systems and consist of mixtures of several chemical constituents including hydrocarbons and oxygenated compounds. EO's also contain many active phytochemicals such as flavonoids, terpenoids, carotenoids, coumarins, curcumin, and so on. Therefore, its application in pest control is well documented.

However, despite well-established properties of essential oil against phytopathogenic fungi, oomycetes, bacteria and weeds, their use in agriculture remains scarce. Owing mostly to their volatile nature and to the thermolability of their components, EO's are susceptible to degradation. EO degradation is affected by several chemical and environmental factors. In view of the close structural relationship between molecules, they may easily convert into each other through different processes, triggered by various factors which may affect them during storage or use, causing their degradation.

Citrus essential oils are a promising tool for sustainable control of economically relevant agricultural pests, however, the formulation preparation, on-field application is limited by several constraints such as high instability and degradability patterns.

Limonene is obtainable from an extract of citrus fruit peel and is present in high concentrations in citrus oil, lemon oil, orange oil, lime oil, grapefruit oil and tangerine oil. Orange oil has a high content of limonene, typically comprising at least 90% limonene by weight of the orange oil. The amount of aldehydes contained in orange oil, both terpenes (neral and geranial) and aliphatic aldehydes (decanal and octanal), crucially affect the olfactory notes of orange oil. The concentration of carbonyl compounds, which substantially influences orange oil value, exceeds 1% in EO's from organically grown oranges, whereas is less than 0.4% in oils containing pesticides.

However, the volatile nature of limonene and its degradability in solvents, poses a barrier in the development of formulations comprising limonene or orange oil for agricultural purposes. Therefore, there is a need in the art to provide a formulation comprising a pesticide, namely sulphur and an essential oil, the formulation having efficient activity, efficient retention or recovery of the volatile and good stability under storage conditions.

A suspoemulsion formulation may serve to provide a solution to overcome issues relating to stability of essential oils. However, limitations countered include selection of a surfactant system capable to support both an insoluble organic solid and a liquid. Further, issues relating to Partial solubility of the active ingredients in water or oil phases causes stability problems.

Therefore, while preparing a suspoemulsion formulation or an agrochemical combination comprising essential oils, it becomes essential to provide a stable and efficient formulation/combination which has good stability and efficient retention of the actives in the essential oil.

### SUMMARY OF THE INVENTION

The present disclosure provides an agrochemical combination comprising an inorganic compound and an essential oil. More specifically, the present disclosure provides an agrochemical composition comprising an inorganic compound and an essential oil. The agrochemical composition of the present disclosure provides insecticidal, fungicidal and plant growth enhancing properties.

In an aspect, the present disclosure provides an agrochemical combination comprising an inorganic compound and an essential oil.

In another aspect, the present disclosure provides an agrochemical combination comprising sulphur and orange oil.

In another aspect, the present disclosure provides an agrochemical combination comprising sulphur and limonene.

In another aspect, the present disclosure provides an agrochemical combination comprising sulphur and D-limonene.

In a preferred aspect, the present disclosure provides an agrochemical combination comprising sulphur, D-limonene and silica.

In an aspect, orange oil is adsorbed onto precipitated silica.

The present disclosure provides an agrochemical composition comprising an inorganic compound, an essential oil and agriculturally acceptable excipients.

In an aspect, the present disclosure provides an agrochemical composition comprising;
(i) an inorganic compound,
(ii) an essential oil, and
(iii) agriculturally acceptable excipient(s).

In another aspect, the present disclosure provides an agrochemical composition comprising;
(i) sulphur,
(ii) orange oil, and
(iii) agriculturally acceptable excipient(s).

In another aspect, the present disclosure provides an agrochemical composition comprising;
(i) sulphur,
(ii) limonene, and
(iii) agriculturally acceptable excipient(s).

In another aspect, the present disclosure provides an agrochemical composition comprising;
(i) sulphur,
(ii) D-limonene, and
(iii) agriculturally acceptable excipient(s).

In an aspect, the present disclosure provides a suspoemulsion comprising;
(a) a suspension concentrate comprising;
   (i) an inorganic compound,
   (ii) one or more dispersing agent(s),
(b) an emulsion phase comprising a terpene rich essential oil, and
(c) agriculturally acceptable excipient(s).

In another aspect, the present disclosure provides a suspoemulsion comprising;
(a) a suspension concentrate comprising,
   (i) sulphur, and
   (ii) one or more dispersing agent(s),
(b) an emulsion phase comprising orange oil, and
(c) agriculturally acceptable excipient(s).

In another aspect, the present disclosure provides a suspoemulsion comprising,
(a) a suspension concentrate comprising,
   (i) sulphur,
   (ii) one or more dispersing agent(s),
(b) an emulsion phase comprising limonene, and
(c) agriculturally acceptable excipient(s).

In yet another aspect, the present disclosure provides a suspoemulsion comprising;
(a) a suspension concentrate comprising,
   (i) sulphur, and
   (ii) one or more dispersing agent(s),
(b) an emulsion phase comprising D-limonene, and
(c) agriculturally acceptable excipient(s).

In an aspect, the present disclosure provides a process for preparing a suspoemulsion comprising an inorganic compound, an essential oil, and agriculturally acceptable excipient(s).

In an aspect, the present disclosure provides a process for preparing a suspoemulsion comprising;
(i) preparing a suspension concentrate (SC) phase comprising an inorganic compound and one or more dispersing agent(s),
(ii) preparing an emulsion phase comprising an essential oil and an emulsifying component, and
(iii) combining the SC phase with the emulsion phase to produce the suspoemulsion.

In an aspect, the present disclosure provides a process for preparing a suspoemulsion comprising;
(i) preparing a suspension concentrate (SC) phase comprising an inorganic compound and one or more dispersant(s);
(ii) preparing an oil in water emulsion (EW) phase or an emulsion concentrate (EC) phase comprising an essential oil,
(iii) combining the SC phase with the EW or the EC phase to produce the suspoemulsion.

In an aspect, the present disclosure provides a process for preparing a suspoemulsion comprising sulphur and orange oil.

In another aspect, the present disclosure provides a process for preparing a suspoemulsion comprising;
(i) preparing a suspension concentrate (SC) phase comprising sulphur and one or more dispersant(s);
(ii) preparing an oil in water emulsion (EW) phase or an emulsion concentrate (EC) phase comprising orange oil and an emulsifying component,
(iii) combining the SC phase with the EW phase or the EC phase to produce the suspoemulsion.

In an aspect, the present disclosure provides a process for preparing a suspoemulsion comprising sulphur and limonene.

In another aspect, the present disclosure provides a process for preparing a suspoemulsion comprising;
(i) preparing a suspension concentrate (SC) phase comprising sulphur and one or more dispersant(s),
(ii) preparing an oil in water emulsion (EW) phase or an emulsion concentrate (EC) phase comprising limonene and an emulsifying component,
(iii) combining the SC phase with the EW phase or the EC phase to produce the suspoemulsion.

In an aspect, the present disclosure provides the use of the agrochemical combination/composition for controlling insect or fungal infestation in crops.

In one aspect, the present disclosure provides a method of controlling insect or fungal infestation in crops, the method comprising applying at a locus an effective amount of an agrochemical combination comprising an inorganic compound and an essential oil.

In another aspect, the present disclosure provides a method of controlling insect or fungal infestation in crops, the method comprising applying at a locus an effective amount of an agrochemical combination comprising sulphur and orange oil.

In another aspect, the present disclosure provides a method of controlling insect or fungal infestation in crops, the method comprising applying at a locus an effective amount of an agrochemical combination comprising sulphur and limonene.

In one aspect, the present disclosure provides a method of controlling insect or fungal infestation in crops, the method comprising applying at a locus an effective amount of an agrochemical composition comprising an inorganic compound, an essential oil and an agriculturally acceptable excipient.

In one aspect, the present disclosure provides a method of controlling insect or fungal infestation in crops, said method comprising applying at a locus an effective amount of an agrochemical composition comprising sulphur, orange oil and an agriculturally acceptable excipient.

In one aspect, the present disclosure provides a method of controlling insect or fungal infestation in crops, said method comprising applying at a locus an effective amount of an agrochemical composition comprising sulphur, limonene and an agriculturally acceptable excipient.

### DETAILED DESCRIPTION OF INVENTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from essence of the invention disclosed. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

As used herein, the term “about” or “approximately” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the expression of various quantities in terms of “%” or “% w/v” or “% w/w” means the percentage by weight of the total solution or composition unless otherwise specified.

As used herein, the term “agrochemical” used herein is understood to denote an agricultural chemical such as pesticides, fungicides, insecticides, acaricides, herbicides, nematicides, plant growth regulators and can be used interchangeably.

As used herein, the term ‘precipitated silica’ refers to the amorphous form of silica useful to enhance bond strength and as a reinforcing and thickening agent.

The term ‘stable’ referred to herein refers to chemical and/or physical stabilization of the active ingredients in the composition and desired suspensibility and dispersibility of the composition by maintaining homogeneity of the components that impart longer shelf life.

The terms ‘recovery or retention of limonene’ or ‘recovery or retention of orange oil’ or ‘recovery or retention of essential oil’ as used herein refers to the concentration of limonene or orange oil or essential in the agrochemical composition of the present disclosure, after a particular storage period or at AHS conditions (Accelerated heat stability).

The terms “ambient temperature” and “room temperature” as utilized herein shall generally mean any suitable temperature found in a laboratory or other working quarter, and is generally not below about 15° C. nor above about 30° C.

The physicochemical studies of the compositions/formulation is performed according to the CIPAC standard method.

The term AHS refer to Accelerated heat stability (AHS), wherein experimental studies are carried out to determine the stability of the composition after 14 days of preparing the said composition at a temperature of 54° C.

As used herein, the term “agrochemically acceptable salt” means a salt which is acceptable for use in agrochemical or horticultural use. The salts referred to herein are agrochemically acceptable salts.

As used herein, the term ‘pest’ applies to all noxious and damaging organisms, including insects, mites, fungi, nematodes, plant pathogens, weeds, and vertebrates. A pest is an organism living and growing where they are not wanted and can cause damage to plants, humans, structures, and other creatures.

As used herein, the term “fungicide” denotes a compound which controls or modifies the growth of fungus.

As used herein, the term “fungicidal” refers to the ability of a substance to control or modify the growth of fungus or its spores.

As used herein, the term “fungicidally effective amount” indicates the quantity of such a compound or combination of such compounds which is capable of controlling or modifying the growth of the fungus.

As used herein, the term “insecticide” denotes a compound which controls or modifies the growth of insects or larvae.

As used herein, the term “insecticidal” refers to the ability of a substance to control or modify the growth of insects or larvae.

As used herein, the term “insecticidally effective amount” indicates the quantity of such a compound or combination of such compounds which is capable of controlling or modifying the growth of insects or larvae.

The terms “effective amount” or “agriculturally acceptable effective amount”, refer to an amount of an active ingredient, such as in the disclosed combination(s), which has an adverse effect on a fungus, treats or prevents a fungal disease in a plant, and is not significantly toxic to the plant being treated. The adverse effect can include killing of the fungus (fungicidal), preventing growth of the fungus, blocking of biosynthetic pathway(s), or a combination thereof.

As used herein, the term “control” or “disease control” refers to the treatment and/or prevention of a disease, and specifically, a fungal disease. Controlling effects include any and all deviations from the natural development of the disease, for example: killing of the fungal agent, retardation of disease development, and decrease in amount or degree of the fungal disease.

As used herein, the term “plant(s)” or “crop(s)” refers to the physical parts of a plant, including for example, seeds, seedlings, saplings, roots, tubers, stems, stalks, foliage, and fruits. This term also encompasses plant crops such as fruits. The term “plant” is limited to a living plant organism which expresses a set of characteristics determined by its single, genetic makeup or genotype, which can be duplicated through asexual reproduction, but which cannot otherwise be “made” or “manufactured.

The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “crop” refers both to growing and harvested crops.

As used herein, the term “locus” refers to the vicinity, area, or place in which the plants are growing, where plant propagation materials of the plants are sown, and/or where the plant propagation materials of the plants will be placed into soil.

As used herein, the term “plant propagation material” is understood to refer to all of the generative parts of a plant, such as seeds, vegetative material such as cuttings or tubers, roots, fruits, tubers, bulbs, rhizomes, and other parts of plants, germinated plants, and/or young plants which are to be transplanted after germination or after emergence from the soil. These young plants may be protected prior to transplantation by a total or partial immersion treatment/system.

As used herein, the term “seed” embraces seeds and plant propagules of all kinds including but not limited to true seeds, seed pieces, suckers, corms, bulbs, fruit, tubers, grains, cuttings, cut shoots and the like.

The term “agriculturally acceptable amount of active” refers to an amount of an active that kills or inhibits the pest on which control is desired, in an amount not significantly toxic to the plant being treated.

To “control” or “controlling” means to inhibit, and/or supress the ability of the insect to grow and/or proliferate, or to limit insect related damage or loss in crop plants or denotes control and prevention of the insects. Controlling effects include all deviation from natural development, for example: killing, retardation, decrease in insect population.

The present inventors have found that a combination comprising an inorganic compound such as sulphur and a terpene rich essential oil, i.e. orange oil has effective pesticidal properties. Moreover, the present inventors have provided an aqueous suspoemulsion comprising sulphur and orange oil, wherein orange oil is retained in the composition over long storage periods.

In an embodiment, the present disclosure provides an agrochemical combination comprising:
(i) an inorganic compound, and
(ii) an essential oil.

In an embodiment, the inorganic compound is sulphur or a copper salt.

In a preferred embodiment, the inorganic compound is sulphur.

In an embodiment, the copper salt is selected from the group comprising copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate, or copper sulfate pentahydrate.

In an embodiment, the essential oil is a terpene rich oil.

In another embodiment, the terpene rich oil is from the group comprising orange oil, hemp oil, eucalyptus oil, bergamot oil, citrus oil, pine oil.

In a preferred embodiment, the terpene rich essential oil is orange oil.

In a preferred embodiment, the present disclosure provides an agrochemical combination comprising sulphur and orange oil.

In another embodiment, orange oil comprises limonene.

In another embodiment, orange oil comprises D-limonene.

In another preferred embodiment, the present disclosure provides an agrochemical combination comprising sulphur, and limonene.

In another preferred embodiment, the present disclosure provides an agrochemical combination comprising sulphur, and D-limonene.

In an embodiment, the present disclosure provides an agrochemical combination comprising:
(i) an inorganic compound, and
(ii) an essential oil,
   wherein the weight ratio of the inorganic compound and the essential oil is ranging from 1:0.1 to 80:1.

In an embodiment, the present disclosure provides an agrochemical combination comprising:
(i) an inorganic compound, and
(ii) an essential oil,
   wherein the weight ratio of the inorganic compound and the essential oil is ranging from 10:1 to 70:1.

In an embodiment, the present disclosure provides an agrochemical combination comprising:
(i) an inorganic compound, and
(ii) an essential oil,
   wherein the weight ratio of the inorganic compound and the essential oil is ranging from 20:1 to 60:1.

In an embodiment, the present disclosure provides an agrochemical combination comprising:
(i) an inorganic compound, and
(ii) an essential oil,
   wherein the weight ratio of the inorganic compound and the essential oil is ranging from 30:1 to 60:1.

In an embodiment, the present disclosure provides an agrochemical combination comprising:
(i) an inorganic compound, and
(ii) an essential oil,
   wherein the weight ratio of the inorganic compound and the essential oil is 50:1.

In an embodiment, the present disclosure provides an agrochemical combination comprising:
(i) sulphur, and
(ii) a terpene rich essential oil,
   wherein the weight ratio of sulphur and the terpene rich essential oil is ranging from 1:0.1 to 80:1.

In an embodiment, the present disclosure provides an agrochemical combination comprising:
(i) sulphur, and
(ii) a terpene rich essential oil,
   wherein the weight ratio of sulphur and the terpene rich essential oil is ranging from 10:1 to 70:1.

In an embodiment, the present disclosure provides an agrochemical combination comprising:
(i) sulphur, and
(ii) a terpene rich essential oil,
   wherein the weight ratio of sulphur and the terpene rich essential oil is ranging from 20:1 to 60:1.

In an embodiment, the present disclosure provides an agrochemical combination comprising:
(i) sulphur, and
(ii) a terpene rich essential oil,
   wherein the weight ratio of sulphur and the terpene rich essential oil is ranging from 30:1 to 60:1.

In an embodiment, the present disclosure provides an agrochemical combination comprising:
(i) sulphur, and
(ii) a terpene rich essential oil,
   wherein the weight ratio of sulphur and the terpene rich essential oil is 50:1.

In a preferred embodiment, the present disclosure provides an agrochemical combination comprising:
(i) sulphur, and
(ii) orange oil,
   wherein the weight ratio of sulphur and orange oil is ranging from 1:0.1 to 80:1.

In a preferred embodiment, the present disclosure provides an agrochemical combination comprising:
(i) sulphur, and
(ii) orange oil,
   wherein the weight ratio of sulphur and orange oil is ranging from 10:1 to 70:1.

In a preferred embodiment, the present disclosure provides an agrochemical combination comprising:
(i) sulphur, and
(ii) orange oil,
   wherein the weight ratio of sulphur and orange oil is ranging from 20:1 to 60:1.

In a preferred embodiment, the present disclosure provides an agrochemical combination comprising:
(i) sulphur, and
(ii) orange oil,
   wherein the weight ratio of sulphur and orange oil is ranging from 30:1 to 60:1.

In a preferred embodiment, the present disclosure provides an agrochemical combination comprising:
(i) sulphur, and
(ii) orange oil,
   wherein the weight ratio of sulphur and orange oil is 50:1.

In a preferred embodiment, the present disclosure provides an agrochemical combination comprising:
(i) sulphur, and
(ii) limonene,
   wherein the weight ratio of sulphur and limonene is ranging from 1:0.1 to 80:1.

In a preferred embodiment, the present disclosure provides an agrochemical combination comprising:
(i) sulphur, and
(ii) limonene,
   wherein the weight ratio of sulphur and limonene is ranging from 10:1 to 70:1.

In a preferred embodiment, the present disclosure provides an agrochemical combination comprising:
(i) sulphur, and
(ii) limonene,
   wherein the weight ratio of sulphur and limonene is ranging from 20:1 to 60:1.

In a preferred embodiment, the present disclosure provides an agrochemical combination comprising:
(i) sulphur, and
(ii) limonene,
   wherein the weight ratio of sulphur and limonene is ranging from 30:1 to 60:1.

In a preferred embodiment, the present disclosure provides an agrochemical combination comprising:
(i) sulphur, and
(ii) limonene,
   wherein the weight ratio of sulphur and limonene is 50:1.

In a preferred embodiment, the present disclosure provides an agrochemical combination comprising:
(i) sulphur, and
(ii) D-limonene,
   wherein the weight ratio of sulphur and D-limonene is ranging from 1:0.1 to 80:1.

In a preferred embodiment, the present disclosure provides an agrochemical combination comprising:
(i) sulphur, and
(ii) D-limonene,
   wherein the weight ratio of sulphur and D-limonene is ranging from 10:1 to 70:1.

In a preferred embodiment, the present disclosure provides an agrochemical combination comprising:
(i) sulphur, and
(ii) D-limonene,
   wherein the weight ratio of sulphur and D-limonene is ranging from 20:1 to 60:1.

In a preferred embodiment, the present disclosure provides an agrochemical combination comprising:
(i) sulphur, and
(ii) D-limonene,
   wherein the weight ratio of sulphur and D-limonene is ranging from 30:1 to 60:1.

In a preferred embodiment, the present disclosure provides an agrochemical combination comprising:
(i) sulphur, and
(ii) D-limonene,
   wherein the weight ratio of sulphur and D-limonene is 50:1.

In a further embodiment, the present disclosure provides an agrochemical combination comprising an inorganic compound, a terpene rich essential oil and silica.

In another preferred embodiment, the present disclosure provides an agrochemical combination comprising sulphur, orange oil and silica.

In another preferred embodiment, the present disclosure provides an agrochemical combination comprising sulphur, limonene and silica.

In another preferred embodiment, the present disclosure provides an agrochemical combination comprising sulphur, D-limonene and silica.

In an embodiment, orange oil is adsorbed onto silica.

In a preferred embodiment, orange oil is adsorbed onto precipitated silica.

In an embodiment, orange oil is adsorbed onto silica in a ratio ranging from 10:1 to 1:1.

In an embodiment, orange oil is adsorbed onto silica in a ratio ranging from 5:1 to 1:1.

In an embodiment, orange oil is adsorbed onto precipitated silica in a ratio ranging from 10:1 to 1:1.

In an embodiment, orange oil is adsorbed onto precipitated silica in a ratio ranging from 5:1 to 1:1.

In an embodiment, orange oil is adsorbed onto precipitated silica in a ratio of 3:1.

In an embodiment, orange oil is adsorbed onto precipitated silica in a ratio of 2:1.

In an embodiment, orange oil is adsorbed onto precipitated silica in a ratio of 1:1.

In a preferred embodiment, the present disclosure provides an agrochemical combination comprising:
(i) an inorganic compound,
(ii) orange oil, and
(iii) precipitated silica,
   wherein the weight ratio of an inorganic compound and orange oil is ranging from 30:1 to 60:1, and orange oil is adsorbed onto precipitated silica in a ratio ranging from 5:1 to 1:1.

In a preferred embodiment, the present disclosure provides an agrochemical combination comprising:
(i) an inorganic compound,
(ii) orange oil, and
(iii) precipitated silica,
   wherein the weight ratio of an inorganic compound and orange oil is 50:1, and orange oil is adsorbed onto precipitated silica in a ratio ranging from 5:1 to 1:1.

In a preferred embodiment, the present disclosure provides an agrochemical combination comprising:
(i) an inorganic compound,
(ii) orange oil, and
(iii) precipitated silica,
   wherein the weight ratio of the inorganic compound and orange oil is 50:1, and orange oil is adsorbed onto precipitated silica in a ratio ranging from 3:1 to 1:1.

In a preferred embodiment, the present disclosure provides an agrochemical combination comprising:
(i) sulphur,
(ii) orange oil, and
(iii) precipitated silica,
   wherein the weight ratio of sulphur and orange oil is ranging from 30:1 to 60:1, and orange oil is adsorbed onto precipitated silica in a ratio ranging from 5:1 to 1:1.

In a preferred embodiment, the present disclosure provides an agrochemical combination comprising:
(i) sulphur,
(ii) orange oil, and
(iii) precipitated silica,
   wherein the weight ratio of sulphur and orange oil is 50:1, and orange oil is adsorbed onto precipitated silica in a ratio ranging from 5:1 to 1:1.

In a preferred embodiment, the present disclosure provides an agrochemical combination comprising:
(i) sulphur,
(ii) orange oil, and
(iii) precipitated silica,
   wherein the weight ratio of sulphur and orange oil is 50:1, and orange oil is adsorbed onto precipitated silica in a ratio ranging from 3:1 to 1:1.

The present disclosure provides an agrochemical composition comprising an inorganic compound and an essential oil. More specifically, the present disclosure provides an agrochemical composition comprising sulphur and an essential oil, i.e. orange oil.

In an embodiment, the present disclosure provides an agrochemical composition comprising:
(i) an inorganic compound,
(ii) an essential oil, and
(iii) agriculturally acceptable excipient(s).

In an embodiment, the present disclosure provides an agrochemical composition comprising:
(i) an inorganic compound,
(ii) a terpene rich essential oil, and
(iii) agriculturally acceptable excipient(s).

In another embodiment, the present disclosure provides an agrochemical composition comprising:
(i) sulphur,
(ii) orange oil, and
(iii) agriculturally acceptable excipient(s).

In another embodiment, the present disclosure provides an agrochemical composition comprising:
(i) sulphur,
(ii) limonene, and
(iii) agriculturally acceptable excipient(s).

In another embodiment, the present disclosure provides an agrochemical composition comprising:
(i) sulphur,
(ii) D-limonene, and
(iii) agriculturally acceptable excipient(s).

In another embodiment, the present disclosure provides an agrochemical composition comprising:
(i) sulphur,
(ii) orange oil,
(iii) precipitated silica, and
(iv) agriculturally acceptable excipient(s),
   wherein orange oil is adsorbed onto precipitated silica in a ratio ranging from 10:1 to 1:1.

In another embodiment, the present disclosure provides an agrochemical composition comprising:
(i) sulphur,
(ii) orange oil,
(iii) precipitated silica, and
(iv) agriculturally acceptable excipient(s),
   wherein orange oil is adsorbed onto precipitated silica in a ratio ranging from 5:1 to 1:1.

In another embodiment, the present disclosure provides an agrochemical composition comprising:
(i) sulphur,
(ii) orange oil,
(iii) precipitated silica, and
(iv) agriculturally acceptable excipient(s),
   wherein orange oil is adsorbed onto precipitated silica in a ratio ranging from 3:1 to 1:1.

In an embodiment, the present disclosure provides an agrochemical composition comprising:
(i) an inorganic compound in a concentration ranging from 1% to 80% w/v of the composition,
(ii) a terpene rich essential oil in a concentration ranging from 1% to 20% w/v of the composition, and
(iii) agriculturally acceptable excipient(s) in a concentration ranging from 0.1% to 50% w/v of the composition.

In an embodiment, the present disclosure provides an agrochemical composition comprising:
(i) an inorganic compound in a concentration ranging from 10% to 60% w/v of the composition,
(ii) a terpene rich essential oil in a concentration ranging from 1% to 10% w/v of the composition, and
(iii) agriculturally acceptable excipient(s) in a concentration ranging from 0.1% to 50% w/v of the composition.

In an embodiment, the present disclosure provides an agrochemical composition comprising:
(i) an inorganic compound in a concentration ranging from 20% to 50% w/v of the composition,
(ii) a terpene rich essential oil in a concentration ranging from 1% to 5% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 1% to 80% w/v of the composition,
(ii) orange oil in a concentration ranging from 1% to 20% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 10% to 60% w/v of the composition,
(ii) orange oil in a concentration ranging from 1% to 10% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 20% to 50% w/v of the composition,
(ii) orange oil in a concentration ranging from 1% to 5% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 1% to 80% w/v of the composition,
(ii) limonene in a concentration ranging from 1% to 20% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 10% to 60% w/v of the composition,
(ii) limonene in a concentration ranging from 1% to 10% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 20% to 50% w/v of the composition,
(ii) limonene in a concentration ranging from 1% to 5% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 1% to 80% w/v of the composition,
(ii) D-limonene in a concentration ranging from 1% to 20% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 10% to 60% w/v of the composition,
(ii) D-limonene in a concentration ranging from 1% to 10% w/v of the composition, and
(iii) agriculturally acceptable excipient(s) in a concentration ranging from 0.1% to 50% w/v of the composition.

In another embodiment, the present disclosure provides an agrochemical composition comprising:
(i) sulphur in a concentration ranging from 20% to 50% w/v of the composition,
(ii) D-limonene in a concentration ranging from 1% to 5% w/v of the composition, and
(iii) agriculturally acceptable excipient(s) in a concentration ranging from 0.1% to 50% w/v of the composition.

In an embodiment, the present disclosure provides an agrochemical composition comprising:
(i) an inorganic compound in a concentration ranging from 1% to 80% w/v of the composition,
(ii) a terpene rich essential oil in a concentration ranging from 1% to 20% w/v of the composition,
(iii) precipitated silica in a concentration ranging from 0.1% to 10% w/v of the composition, and
(iv) agriculturally acceptable excipient(s) in a concentration ranging from 0.1% to 40% w/v of the composition,
   wherein terpene rich essential oil is adsorbed onto precipitated silica in a ratio ranging from 10:1 to 1:1.

In an embodiment, the present disclosure provides an agrochemical composition comprising:
(i) an inorganic compound in a concentration ranging from 10% to 60% w/v of the composition,
(ii) a terpene rich essential oil in a concentration ranging from 1% to 10% w/v of the composition,
(iii) precipitated silica in a concentration ranging from 0.1% to 5% w/v of the composition, and
(iv) agriculturally acceptable excipient(s) in a concentration ranging from 0.1% to 50% w/v of the composition,
   wherein terpene rich essential oil is adsorbed onto precipitated silica in a ratio ranging from 10:1 to 1:1.

In an embodiment, the present disclosure provides an agrochemical composition comprising:
(i) an inorganic compound in a concentration ranging from 20% to 50% w/v of the composition,
(ii) a terpene rich essential oil in a concentration ranging from 1% to 5% w/v of the composition,
(iii) precipitated silica in a concentration ranging from 0.1% to 2.5% w/v of the composition, and
(iv) agriculturally acceptable excipient(s) in a concentration ranging from 0.1% to 50% w/v of the composition,
   wherein terpene rich essential oil is adsorbed onto precipitated silica in a ratio ranging from 10:1 to 1:1.

In an embodiment, the present disclosure provides an agrochemical composition comprising:
(i) an inorganic compound in a concentration ranging from 1% to 80% w/v of the composition,
(ii) orange oil in a concentration ranging from 1% to 20% w/v of the composition,
(iii) precipitated silica in a concentration ranging from 0.1% to 10% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) an inorganic compound in a concentration ranging from 10% to 60% w/v of the composition,
(ii) orange oil in a concentration ranging from 1% to 10% w/v of the composition,
(iii) precipitated silica in a concentration ranging from 0.1% to 5% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) an inorganic compound in a concentration ranging from 20% to 50% w/v of the composition,
(ii) orange oil in a concentration ranging from 1% to 5% w/v of the composition,
(iii) precipitated silica in a concentration ranging from 0.1% to 2.5% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) sulphur in a concentration ranging from 1% to 80% w/v of the composition,
(ii) orange oil in a concentration ranging from 1% to 20% w/v of the composition,
(iii) precipitated silica in a concentration ranging from 0.1% to 10% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) sulphur in a concentration ranging from 10% to 60% w/v of the composition,
(ii) orange oil in a concentration ranging from 1% to 10% w/v of the composition,
(iii) precipitated silica in a concentration ranging from 0.1% to 5% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) sulphur in a concentration ranging from 20% to 50% w/v of the composition,
(ii) orange oil in a concentration ranging from 1% to 5% w/v of the composition,
(iii) precipitated silica in a concentration ranging from 0.1% to 2.5% w/v of the composition, and
(iv) agriculturally acceptable excipient(s) in a concentration ranging from 0.1% to 50% w/v of the composition,
   wherein orange oil is adsorbed onto precipitated silica in a ratio ranging from 10:1 to 1:1.

In an embodiment, the present disclosure provides an agrochemical composition comprising:
(i) sulphur in a concentration ranging from 20% to 50% w/v of the composition,
(ii) orange oil in a concentration ranging from 1% to 5% w/v of the composition,
(iii) precipitated silica in a concentration ranging from 0.1% to 2.5% w/v of the composition, and
(iv) agriculturally acceptable excipient(s) in a concentration ranging from 0.1% to 50% w/v of the composition,
   wherein orange oil is adsorbed onto precipitated silica in a ratio ranging from 5:1 to 1:1.

In an embodiment, the agriculturally acceptable excipient is selected from anti-freeze agents, emulsifiers, preservatives, defoamers, and thickening agents.

In an embodiment, the agrochemical composition is a liquid formulation.

In an embodiment, the agrochemical composition is a suspoemulsion.

In an embodiment, the present disclosure provides a suspoemulsion comprising:
(a) a suspension concentrate comprising:
   (i) a first active ingredient comprising an inorganic compound, and
   (ii) one or more dispersing agent(s);
(b) an emulsion phase comprising a terpene rich essential oil, and
(c) agriculturally acceptable excipients.

In an embodiment, the present disclosure provides a suspoemulsion comprising:
(a) a suspension concentrate comprising:
   (i) sulphur, and
   (ii) one or more dispersing agent(s);
(b) an emulsion phase comprising orange oil, and
(c) agriculturally acceptable excipients.

In an embodiment, the present disclosure provides a suspoemulsion comprising:
(a) a suspension concentrate comprising:
   (i) sulphur, and
   (ii) one or more dispersing agent(s);
(b) an emulsion phase comprising limonene, and
(c) agriculturally acceptable excipients.

In an embodiment, the present disclosure provides a suspoemulsion comprising:
(a) a suspension concentrate comprising:
   (i) sulphur, and
   (ii) one or more dispersing agent(s);
(b) an emulsion phase comprising D-limonene, and
(c) agriculturally acceptable excipients.

In an embodiment, the present disclosure provides a suspoemulsion comprising:
(a) a suspension concentrate comprising:
   (i) a first active ingredient comprising an inorganic compound, and
   (ii) one or more dispersing agent(s);
(b) an oil in water emulsion phase comprising a terpene rich essential oil, and
(c) agriculturally acceptable excipients.

In an embodiment, the present disclosure provides a suspoemulsion comprising:
(a) a suspension concentrate comprising:
   (i) sulphur, and
   (ii) one or more dispersing agent(s);
(b) an oil in water emulsion phase comprising orange oil, and
(c) agriculturally acceptable excipients.

In an embodiment, the present disclosure provides a suspoemulsion comprising:
(a) a suspension concentrate comprising:
   (i) sulphur, and
   (ii) one or more dispersing agent(s);
(b) an oil in water emulsion phase comprising limonene, and
(c) agriculturally acceptable excipients.

In an embodiment, the present disclosure provides a suspoemulsion comprising:
(a) a suspension concentrate comprising:
   (iii) sulphur, and
   (iv) one or more dispersing agent(s);
(b) an oil in water emulsion phase comprising D-limonene, and
(c) agriculturally acceptable excipients.

In an embodiment, the dispersing agent is an anionic or non-ionic surfactant.

In an embodiment, the dispersing agent is an anionic surfactant comprising lignosulfonate blend, sodium lignosulphonate, calcium lignosulphonate, aluminium lignosulfonate, modified kraft lignosulfonates, sodium naphathalene formaldehyde condensates, sodium salt of phenol formaldehyde condensates and sodium polycarboxaltes.

In an embodiment, the anionic surfactant is a lignosulfonate-based salt.

In an embodiment, the lignosulfonate salt is sodium lignosulfonate.

In an embodiment, the anionic surfactant is present in a concentration ranging from 0.1% to 20% w/v of the composition.

In an embodiment, the anionic surfactant is present in a concentration ranging from 5% to 15% w/v of the composition.

In an embodiment, the lignosulfonate salt is present in a concentration ranging from 0.1% to 20% w/v of the composition.

In an embodiment, the lignosulfonate salt is present in a concentration ranging from 5% to 15% w/v of the composition.

In an embodiment, silica is added to the emulsion phase.

In an embodiment, silica is added to the oil in water emulsion (EW).

In an embodiment, silica is precipitated silica.

In an embodiment, silica is present in a concentration ranging from 0.1% to 10% w/v of the composition.

In an embodiment, precipitated silica is present in a concentration ranging from 0.5% to 5% w/v of the composition.

In an embodiment, precipitated silica is present in a concentration ranging from 0.1% to 10% w/v of the composition.

In an embodiment, precipitated silica is present in a concentration ranging from 0.1% to 5% w/v of the composition.

In an embodiment, precipitated silica is present in a concentration ranging from 0.1% to 2.5% w/v of the composition.

In an embodiment, precipitated silica is present in a concentration of 0.5% w/v of the composition.

In an embodiment, precipitated silica is present in a concentration of 2% w/v of the composition.

In an embodiment, the emulsion phase comprises an oil in water emulsion, water in oil emulsion or an emulsifiable concentrate or a microemulsion (ME).

In a preferred embodiment, the emulsion phase comprises an oil in water emulsion.

In an embodiment, the present disclosure provides a suspoemulsion comprising;
(a) a suspension concentrate comprising,
   (i) a first active ingredient comprising an inorganic compound, and
   (ii) one or more dispersing agent(s);
(b) an emulsion phase comprising a terpene rich essential oil,
(c) precipitated silica, and
(d) agriculturally acceptable excipients,
   wherein precipitated silica is added to the emulsion phase to increase the adsorption of the terpene rich essential oil.

In an embodiment, the present disclosure provides a suspoemulsion comprising;
(a) a suspension concentrate comprising,
   (i) sulphur, and
   (ii) one or more dispersing agent(s);
(b) an emulsion phase comprising orange oil,
(c) precipitated silica, and
(d) agriculturally acceptable excipients,
   wherein precipitated silica is added to the emulsion phase to increase the adsorption of orange oil.

In an embodiment, the present disclosure provides a suspoemulsion comprising;
(a) a suspension concentrate comprising,
   (i) sulphur, and
   (ii) one or more dispersing agent(s);
(b) an emulsion phase comprising limonene,
(c) precipitated silica, and
(d) agriculturally acceptable excipients,
   wherein precipitated silica is added to the emulsion phase to increase the adsorption of limonene.

In an embodiment, the present disclosure provides a suspoemulsion comprising;
(a) a suspension concentrate comprising,
   (i) sulphur, and
   (ii) one or more dispersing agent(s);
(b) an emulsion phase comprising D-limonene,
(c) precipitated silica, and
(d) agriculturally acceptable excipients,
   wherein precipitated silica is added to the emulsion phase to increase the adsorption of D-limonene.

In an embodiment, the present disclosure provides a suspoemulsion comprising:
(a) a suspension concentrate comprising
   (i) a first active ingredient comprising an inorganic compound, and
   (ii) one or more dispersing agent(s);
(b) an oil in water emulsion phase comprising a terpene rich essential oil,
(c) precipitated silica, and
(d) agriculturally acceptable excipients,
   wherein precipitated silica is added to the oil in water emulsion phase to increase the adsorption of the terpene rich essential oil.

In an embodiment, the present disclosure provides a suspoemulsion comprising:
(a) a suspension concentrate comprising;
   (i) sulphur, and
   (ii) one or more dispersing agent(s);
(b) an oil in water emulsion phase comprising orange oil,
(c) precipitated silica, and
(d) agriculturally acceptable excipients,
   wherein precipitated silica is added to the oil in water emulsion phase to increase the adsorption of orange oil.

In an embodiment, the present disclosure provides a suspoemulsion comprising:
(a) a suspension concentrate comprising;
   (i) sulphur, and
   (ii) one or more dispersing agent(s);
(b) an oil in water emulsion phase comprising limonene,
(c) precipitated silica, and
(d) agriculturally acceptable excipients,
   wherein precipitated silica is added to the oil in water emulsion phase to increase the adsorption of limonene.

In an embodiment, the present disclosure provides a suspoemulsion comprising:
(a) a suspension concentrate comprising:
   (i) sulphur, and
   (ii) one or more dispersing agent(s);
(b) an oil in water emulsion phase comprising D-limonene,
(c) precipitated silica, and
(d) agriculturally acceptable excipients,
   wherein precipitated silica is added to the emulsion phase to increase the adsorption of D-limonene.

In an embodiment, the present disclosure provides a suspoemulsion comprising:
(a) a suspension concentrate comprising;
   (i) sulphur, and
   (ii) alkali metal salt of lignosulfonate;
(b) an oil in water emulsion phase comprising orange oil,
(c) precipitated silica, and
(d) agriculturally acceptable excipients,
   wherein precipitated silica is added to the oil in water emulsion phase to increase the adsorption of orange oil.

In an embodiment, the present disclosure provides a suspoemulsion comprising:
(a) a suspension concentrate comprising;
   (i) sulphur, and
   (ii) alkali metal salt of lignosulfonate;
(b) an oil in water emulsion phase comprising limonene,
(c) precipitated silica, and
(d) agriculturally acceptable excipients,
   wherein precipitated silica is added to the oil in water emulsion phase to increase the adsorption of limonene.

In an embodiment, the present disclosure provides a suspoemulsion comprising:
(a) a suspension concentrate comprising:
   (i) sulphur, and
   (ii) alkali metal salt of lignosulfonate;
(b) an oil in water emulsion phase comprising D-limonene,
(c) precipitated silica, and
(d) agriculturally acceptable excipients,
   wherein precipitated silica is added to the emulsion phase to increase the adsorption of D-limonene.

In a preferred embodiment, the present disclosure provides a suspoemulsion comprising:
(a) a suspension concentrate comprising;
   (i) sulphur, and
   (ii) sodium lignosulfonate;
(b) an oil in water emulsion phase comprising orange oil,
(c) precipitated silica, and
(d) agriculturally acceptable excipients,
   wherein precipitated silica is added to the oil in water emulsion phase to increase the adsorption of orange oil.

In a preferred embodiment, the present disclosure provides a suspoemulsion comprising:
(a) a suspension concentrate comprising;
   (i) sulphur, and
   (ii) sodium lignosulfonate;
(b) an oil in water emulsion phase comprising limonene,
(c) precipitated silica, and
(d) agriculturally acceptable excipients,
   wherein precipitated silica is added to the oil in water emulsion phase to increase the adsorption of limonene.

In a preferred embodiment, the present disclosure provides a suspoemulsion comprising:
(a) a suspension concentrate comprising:
   (i) sulphur, and
   (ii) sodium lignosulfonate;
(b) an oil in water emulsion phase comprising D-limonene,
(c) precipitated silica, and
(d) agriculturally acceptable excipients,
   wherein precipitated silica is added to the emulsion phase to increase the adsorption of D-limonene.

In a preferred embodiment, the present disclosure provides a suspoemulsion comprising:
(a) a suspension concentrate comprising,
   (i) sulphur in a concentration ranging from 10% to 60% w/v of the composition, and
   (ii) one or more dispersing agent(s) in a concentration ranging from 0.1% to 20% w/v of the composition;
(b) an emulsion phase comprising orange oil in a concentration ranging from 1% to 10% w/v of the composition,
(c) precipitated silica in a concentration ranging from 0.1% to 5% w/v of the composition, and
(d) agriculturally acceptable excipients in a concentration ranging from 0.1% to 50% w/v of the composition.

In a preferred embodiment, the present disclosure provides a suspoemulsion comprising:
(a) a suspension concentrate comprising;
   (i) sulphur in a concentration ranging from 20% to 50% w/v of the composition, and
   (ii) sodium lignosulfonate in a concentration ranging from 5% to 15% w/v of the composition;
(b) an oil in water emulsion phase comprising orange oil in a concentration ranging from 1% to 5% w/v of the composition,
(c) precipitated silica in a concentration ranging from 0.1% to 2.5% w/v of the composition, and
(d) agriculturally acceptable excipients in a concentration ranging from 0.1% to 50% w/v of the composition,
   wherein precipitated silica is added to the oil in water emulsion phase to increase the adsorption of orange oil.

In a preferred embodiment, the present disclosure provides a suspoemulsion consisting;
(a) a suspension concentrate comprising;
   (i) sulphur in a concentration ranging from 20% to 50% w/v of the composition, and
   (ii) sodium lignosulfonate in a concentration ranging from 5% to 15% w/v of the composition;
(b) an oil in water emulsion phase comprising orange oil in a concentration ranging from 1% to 5% w/v of the composition,
(c) precipitated silica in a concentration ranging from 0.1% to 2.5% w/v of the composition, and
(d) agriculturally acceptable excipients in a concentration ranging from 0.1% to 50% w/v of the composition,
   wherein precipitated silica is added to the oil in water emulsion phase to increase the adsorption of orange oil.

In an embodiment, emulsifiers which can be advantageously employed herein can be readily determined by those skilled in the art and include various non-ionic, anionic, cationic, and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs, or metal phthalocyanine dyestuffs, and trace elements, such as salts of iron, manganese, boron, copper, cobalt, molybdenum, and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In an embodiment, the thickener is silica based.

In a preferred embodiment, the thickener is precipitated silica.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, glycerine, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

In an embodiment, a mixture comprising a thickener and anti-freeze agent is prepared to formulate the oil in water emulsion.

In an embodiment, the mixture comprises xanthan gum and glycerin.

In another embodiment, the mixture comprises xanthan gum and glycerin in a ratio ranging from 0.1:10 to 0.1:1.

In yet another embodiment, the mixture comprises xanthan gum and glycerin in a ratio ranging from 0.1:10 to 0.1:5.

In yet another embodiment, the mixture comprises xanthan gum and glycerin in a ratio of 0.1:6, respectively.

In an embodiment, suitable preservatives include, but are not limited to, quaternary ammonium chlorides; quaternary ammonium carbonates; benzalkonium chloride; iodine containing compounds, such as 3-iodo-2-propynyl butyl carbamate (IPBC); hydantoins, such as dimethylhydantoin and halogenated hydantoins; isothiazolinones; parabens, such as methylparaben, ethylparaben, and propylparaben; dehydroacetic acid and salts thereof; isocil; chloroxylenol; chlorhexidine; phenoxyethanol; benzyl alcohol; phenethyl alcohol; benzoic acid and salts thereof such as sodium benzoate; chlorobutanol; sorbic acid and salts thereof; triclosan; triclocarban; and any combination of any of the foregoing.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Olive Oil, Mono & Di Glyceride, Paraffin Oil, Paraffin Wax, Poly Propylene Glycol, Silicones Oil, Vegetable Fats, Vegetable Fats Sulfate, Vegetable Oil, Vegetable Oil Sulfate, Vegetable Wax, Vegetable Wax Sulfate, agents based on silicon or magnesium stearate.

The agrochemical composition may also comprise one or more antioxidants. Preferably, the agrochemical formulation comprises an antioxidant. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides, and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

In an embodiment, the present disclosure provides the present composition to be stable at Accelerated heat stability conditions and has good recovery of orange oil or limonene, even after 2 months of storage.

In an embodiment, the present disclosure provides a process for preparing an aqueous suspoemulsion comprising:
(i) preparing a suspension concentrate (SC) phase comprising an inorganic compound and one or more dispersing agent(s),
(ii) preparing an emulsified concentrate (EC) phase comprising orange oil, precipitated silica and an emulsifying component including xanthan, and
(iii) combining the EC phase with the SC phase to produce a suspoemulsion.

In an embodiment, the present disclosure provides a process for preparing an aqueous suspoemulsion comprising:
(i) preparing a suspension concentrate (SC) phase comprising sulphur and one or more dispersants,
(ii) preparing an emulsified concentrate (EC) phase comprising orange oil, precipitated silica and an emulsifying component including xanthan,
(iii) combining the EC phase with the SC phase to produce a suspoemulsion.

In an embodiment, the present disclosure provides a process for preparing an aqueous suspoemulsion comprising:
(i) preparing a suspension concentrate (SC) phase comprising an inorganic compound and one or more dispersants,
(ii) preparing an oil in water emulsion (EW) phase comprising orange oil, precipitated silica and an emulsifying component including xanthan, and
(iii) combining the EW phase with the SC phase to produce a suspoemulsion.

In an embodiment, the present disclosure provides a process for preparing an aqueous suspoemulsion comprising:
(i) preparing a suspension concentrate (SC) phase comprising sulphur and one or more dispersants,
(ii) preparing an oil in water emulsion (EW) phase comprising orange oil, precipitated silica and an emulsifying component including xanthan, and
(iii) combining the EW phase with the SC phase to produce a suspoemulsion.

The method of the present disclosure can offer some particular advantages over the conventional methods. The method of the present disclosure effectively protects the crop from insects and improves yield and promotes plant health and has no phytotoxicity.

According to an embodiment of the present disclosure, a kit-of-parts comprising an agrochemical composition is provided. The kit comprises a plurality of components, each of which components may include at least one of the ingredients of the agrochemical composition of the present disclosure.

An embodiment of the present disclosure discloses a kit-of-parts comprising an agrochemical composition of sulphur, orange oil and/or agrochemically acceptable excipient.

In one embodiment of the present disclosure, the kits may include one or more, including all, components that may be used to prepare the agrochemical composition e. g., kits may include pyridylidene insecticide, another insecticide and agrochemically acceptable excipient. One or more of the components may already be combined or pre-formulated. In those embodiments where more than two components are provided in a kit, the components may already be combined and as such are packaged in a single container such as a vial, bottle, can, pouch, bag, or canister.

In one aspect, the present disclosure provides a method of controlling insect or fungal infestation in crops, the method comprising applying at a locus an effective amount of an agrochemical combination comprising an inorganic compound and an essential oil.

In another aspect, the present disclosure provides a method of controlling insect or fungal infestation in crops, the method comprising applying at a locus an effective amount of an agrochemical combination comprising sulphur and orange oil.

In another aspect, the present disclosure provides a method of controlling insect or fungal infestation in crops, the method comprising applying at a locus an effective amount of an agrochemical combination comprising sulphur and limonene.

In one aspect, the present disclosure provides a method of controlling insect or fungal infestation in crops, the method comprising applying at a locus an effective amount of an agrochemical composition comprising an inorganic compound, an essential oil and an agriculturally acceptable excipient.

In one aspect, the present disclosure provides a method of controlling insect or fungal infestation in crops, said method comprising applying at a locus an effective amount of an agrochemical composition comprising sulphur, orange oil, precipitated silica and an agriculturally acceptable excipient.

In one aspect, the present disclosure provides a method of controlling insect or fungal infestation in crops, said method comprising applying at a locus an effective amount of an agrochemical composition comprising sulphur, limonene and an agriculturally acceptable excipient.

In an embodiment, the present invention provides a method of controlling pests comprising applying a suspoemulsion to a locus of a plant or a plant part or a plant propagation material, a suspoemulsion comprising:
(a) a suspension concentrate comprising,
   (i) sulphur, and
   (ii) one or more dispersing agent(s);
(b) an emulsion phase comprising orange oil,
(c) precipitated silica, and
(d) agriculturally acceptable excipient(s);
   wherein orange oil is adsorbed onto precipitated silica in a ratio ranging from 10:1 to 1:1.

In another embodiment, the present invention provides the use of an agrochemcial composition for controlling pests, the composition being a suspoemulsion.

In another embodiment the present invention provides use of a suspoemulsion comprising;
(a) a suspension concentrate comprising,
   (i) sulphur, and
   (ii) one or more dispersing agent(s);
(b) an emulsion phase comprising orange oil,
(c) precipitated silica, and
(d) agriculturally acceptable excipient(s);
   wherein orange oil is adsorbed onto precipitated silica in a ratio ranging from 10:1 to 1:1.

The invention shall now be described with reference to the following specific examples. It should be noted that the examples appended below illustrate rather than limit the invention and that those skilled in the art will be able to design many alternative embodiments without departing from the scope of the present disclosure.

### Examples

### Example 1: Suspoemulsion Formulation of Sulphur and Orange Oil

TABLE 1
Sulfur 700 g/L + Orange Oil g/L 24 SE

| Active ingredient | Concentration % w/v |
|---|---|
| Sulphur | 50.10 |
| Orange Oil | 1.80 |
| Sodium lignosulfonate | 12.40 |
| Precipitated Silica | 2.00 |
| Xanthan gum | 0.15 |
| Glycerin | 6.00 |
| Water | Q.S. |
| Total | 100 |

Process: Water and other excipients were combined under low shear. The dispersant sodium lignosulfonate was added slowly, ensuring rapid wetting to prevent clumping. Sulphur was then added. High shear agitation was used to ensure homogeneity. The mixture is then milled to d(0.5)<1 μm. A thickener mixture is prepared by combining xanthan gum with glycerin. which was added to the remaining water, under high shear. This mixture was added to the millbase under low shear, followed by precipitated silica and Orange oil was added under low shear. The sample is then high sheared to ensure uniformity. Mixing of the resultant suspoemulsion was allowed to continue until the gum swells.

### Example 2: Stability Studies

The physicochemical properties and stability observations of the formulation of Example 1 were recorded as follows:

TABLE 2
Physicochemical stability studies at 2 weeks
at ambient conditions and at Accelerated heat
stability conditions (AHS - 2 weeks at 54° C.)

| | 2 Weeks | 2 Weeks |
|---|---|---|
| Interval | @ Ambient | @ 54° C. |
| Orange oil (% w/w) | 1.72 | 1.70 |
| Orange oil (vs. Ambient) | N/A | 99.13% |
| Density g/mL @20° C. | 1.423 | NT |
| pH neat | 5.5 | 5.4 |
| Viscosity at 20° C. | | |
| CP52 - 2 mins at 6 rpm (cP) | 835.6 | 610.8 |
| Particle Size - Laser | | |
| Diffraction | | |
| d(0.5) μm | 0.639 | 1.036 |
| d(0.9) μm | 2.890 | 3.707 |
| Microscopic appearance | Good dispersion. | Good dispersion. |
| | Crystals all <5 μm. | Crystals all <5 μm. |
| Persistent Foam, 1 min, 342 | 0 | 0 |
| ppm (mL) | | |
| Suspensibility, 30 mins, | 97 | 93 |
| 342 ppm SHW (%) | | |
| Spontaneity, 5 mins, 342 | 96 | 93 |
| ppm SHW (%) | | |
| Wet Sieve Retention (75 μm) | 0.00 | 0.09 |

NT: Not tested
N/A: Not applicable
SHW: Standard hard water

The aforesaid parameters tested show that the present suspoemulsion is stable at ambient temperature as well as at AHS conditions. The concentration of orange oil recovered in the test composition sample was also observed to be within the limit,

### Example 3: Suspoemulsion (SE) Formulation of Sulphur and Orange Oil

TABLE 3
Sulfur 700 g/L + Orange Oil g/L 24 SE

| Active ingredient | Concentration % w/v |
|---|---|
| Sulphur | 49.39 |
| Orange Oil | 1.78 |
| Sodium lignosulfonate | 6.00 |
| Precipitated Silica | 0.50 |
| Xanthan gum | 0.12 |
| Glycerin | 6.00 |
| Water | Q.S. |
| Total | 100 |

Q.S.: Quantity sufficient

Process for preparing the formulation was followed as per the procedure defined in Example 1.

### Example 4: Stability Studies

The physicochemical properties and stability observations of the formulation as per the ingredients of Example 3 (with orange oil concentration at 1.6% w/v) were recorded as follows:

TABLE 4
Physicochemical stability studies at 2 weeks at ambient conditions, at −10°
C. and at Accelerated heat stability conditions (AHS - 2 weeks at 54° C.)

| | | Interval | | | | | |
|---|---|---|---|---|---|---|---|
| | | Specification | | Initial | 2 weeks | | |
| | | Temp(° C.) | | | | | |
| | | N/A | | N/A | −10 | T/C | 54 |
| Limonene Assay (% w/w) | | | | 1.6 | 1.57 | NT | 1.6 |
| Limonene Assay (g/l) | | | | 22.72 | 22.294 | 0 | 22.72 |
| Retention compared to initial | | >95% | | N/A | 98.1% | 0.0% | 100.0% |
| Initial Density g/ml | | | | 1.4 | N/A | N/A | N/A |
| @20° C. | | | | | | | |
| Syneresis (%) | | | | 0.0 | 0.0 | Trace | Trace |
| Sediment (Y/N) | | | | N | N | N | N |
| Spontaneous. | WHO SHW | 342 | ppm | 342 ppm | 342 ppm | 342 ppm | 342 ppm |
| Dispersion | 5% (v/v), at | 60-105% | | 92 | NT | NT | 93 |
| (*CIPAC MT 160), | RT | | | | | | |
| Gravimetricly | | | | | | | |
| Susp. (*CIPAC MT 184) | WHO SHW | 342 | ppm | 342 ppm | 342 ppm | 342 ppm | 342 ppm |
| | 5% (v/v), at | 60-105% | | 95 | NT | NT | 94 |
| | 30 C. | | | | | | |
| pH (neat or 1% v/v) (MT 75.3) | | NA | | 5.41 | 5.51 | 5.51 | 5.47 |
| Visc.@20° C., (cP), CP52 | 2 min@6 rpm | 300-700 | | 795.14 | 742 | 656 | 673 |
| Spindle | | | | | | | |
| Particle Size (*EM | d(0.1) μm | N/A | | NR | 0.42 | 0.44 | 0.525 |
| 6038*) | d(0.5) μm | <3 | | 0.982 | 0.969 | 1.107 | 1.456 |
| | d(0.9) μm | <7 | | 4.508 | 4.434 | 4.678 | 5.537 |
| Persistent Foam, | WHO SHW | 342 | ppm | 57 ppm | 342 ppm | 342 ppm | 342 ppm |
| Water 342 ppm at RT | 2% (v/v), 1 | >60 | mL | 0 | NT | NT | 0.0 |

| (*MT 47.3) | min | | | | | |
|---|---|---|---|---|---|---|
| | 2% (v/v), 12 | N/A | 0 | NT | NT | 0.0 |
| | min | | | | | |
| Wet Sieve 75 μm (%), in Tap water | | <2% | 0.25 | NT | NT | 0.2 |
| (*CIPAC MT 185) | | | | | | |
| Microscopic | Diluted in | N/A | Good | Good | Good | Good |
| appearance | Water | | dispersion | dispersion | dispersion. | dispersion. |
| | | | of crystals | of crystals | Crystals | Crystals |
| | | | mostly <5 | all <5 um. | all <1 um. | all <1 um. |
| | | | um, some | | | |
| | | | up to | | | |
| | | | 20 um. | | | |
| | | | Emulsion | | | |
| | | | droplets | | | |
| | | | all <5 um. | | | |

NT: Not tested
N/A: Not applicable
SHW: Standard hard water
*corresponding method used to test the corresponding parameters
Limonene assay mentioned above is representative of the orange oil content in the formulation

The aforesaid parameters tested show that the present suspoemulsion is stable at −10° C. ambient temperature as well as at AHS conditions. The concentration of orange oil recovered in the test composition sample was also observed to be within the limit,

1. An agrochemical combination comprising;
(i) an inorganic compound, and
(ii) orange oil,
wherein the weight ratio of the inorganic compound and orange oil is ranging from 30:1 to 60:1.

2. The combination as claimed in claim 1, wherein the inorganic compound comprises sulphur or a copper salt.

3. The combination as claimed in claim 1, wherein orange oil comprises D-limonene.

4. The combination as claimed in claim 1, wherein orange oil is adsorbed onto silica in a ratio ranging from 10:1 to 1:1.

5. The combination as claimed in claim 4, wherein silica is precipitated silica.

6. An agrochemical composition comprising;
(a) an inorganic compound,
(b) orange oil,
(c) precipitated silica, and
(d) agriculturally acceptable excipient(s),
wherein orange oil is adsorbed onto precipitated silica in a ratio ranging from 10:1 to 1:1.

7. The composition as claimed in claim 6, wherein the composition is a suspoemulsion (SE).

8. The composition as claimed in claim 6, the inorganic compound comprising sulphur or a copper salt, and orange oil comprising D-limonene.

9. The suspoemulsion as claimed in claim 7, the suspoemulsion comprising:
(a) a suspension concentrate comprising,
(i) sulphur, and
(ii) one or more dispersing agent(s);
(b) an emulsion phase comprising orange oil,
(c) precipitated silica, and
(d) agriculturally acceptable excipients,
wherein orange oil is adsorbed onto silica in a ratio ranging from 10:1 to 1:1.

10. The composition as claimed in claim 9, wherein the emulsion phase comprises an oil in water emulsion (EW), an emulsion concentrate (EC) or a microemulsion (MW).

11. The suspoemulsion as claimed in claim 9, the dispersing agent is an anionic surfactant comprising a lignosulfonate salt.

12. The suspoemulsion as claimed in claim 9, the suspoemulsion comprising;
(a) a suspension concentrate comprising,
(i) sulphur in a concentration ranging from 10% to 60% w/v of the composition, and
(ii) one or more dispersing agent(s) in a concentration ranging from 0.1% to 20% w/v of the composition;
(b) an emulsion phase comprising orange oil in a concentration ranging from 1% to 10% w/v of the composition,
(c) precipitated silica in a concentration ranging from 0.1% to 5% w/v of the composition, and
(d) agriculturally acceptable excipients in a concentration ranging from 0.1% to 50% w/v of the composition.

13. A method of controlling pests comprising applying the suspoemulsion of claim 9 to a locus of a plant or a plant part or a plant propagation material.

14. A method of controlling pests comprising applying the agrochemical composition as claimed in claim 6 to a locus of a plant or a plant part or a plant propagation material.
